(19) United States
(12) Patent Application Publication
(10) Pub. No.: US 2026/0005216 A1
(43) Pub. Date: Jan. 1, 2026

(54) METHOD OF MANUFACTURING ELECTRODE STACK AND METHOD OF MANUFACTURING BATTERY

(71) Applicant: TOYOTA JIDOSHA KABUSHIKI KAISHA, Toyota-shi (JP)

(72) Inventors: Takahiko NAKANO, Nagoya-shi (JP); Shinji Kojima, Nagoya-shi (JP); Yusuke Kintsu, Miyoshi-shi (JP); Hirokazu Takeuchi, Toyota-shi (JP)

(73) Assignee: TOYOTA JIDOSHA KABUSHIKI KAISHA, Toyota-shi (JP)

(21) Appl. No.: 19/047,753

(22) Filed: Feb. 7, 2025

(30) Foreign Application Priority Data
Jun. 26, 2024 (JP) 2024-103215

(51) Int. Cl. H01M 4/04; H01M 4/02

(52) U.S. Cl. CPC H01M 4/0404; H01M 4/043; H01M 2004/027

(57) ABSTRACT

The method of the present disclosure for producing an electrode stack includes the following steps, and does not include a step of winding the laminate in a roll after step (c): coating the electrode mixture slurry on the transfer sheet 20, and drying the coated electrode mixture slurry to form an electrode active material layer (a), a step of providing the current collector 30 (b), and a step of transferring the electrode active material layer to at least one surface of the current collector to obtain a laminate (c). The method of the present disclosure for manufacturing a battery includes manufacturing an electrode stack by the method of the present disclosure.

### CROSS-REFERENCE TO RELATED APPLICATION

This application claims priority to Japanese Patent Application No. 2024-103215 filed on Jun. 26, 2024. The disclosure of the above-identified application, including the specification, drawings, and claims, is incorporated by reference herein in its entirety.

### BACKGROUND

### 1. Technical Field

The present disclosure relates to a method of manufacturing an electrode stack and a method of manufacturing a battery.

### 2. Description of Related Art

There has been developed a technique of manufacturing an electrode stack for a battery, as disclosed in Japanese Unexamined Patent Application Publication No. 2011-216227 (JP 2011-216227 A), Japanese Unexamined Patent Application Publication No. 2024-034047 (JP 2024-034047 A), and Japanese Unexamined Patent Application Publication No. 2006-128039 (JP 2006-128039 A).

JP 2011-216227 A discloses an electrode material drying method including applying an electrode material containing a solvent to a sub-current collector. The electrode material drying method includes an intermediate heating step of heating the electrode material applied to the sub-current collector to a temperature at which the saturated vapor pressure is 100 mmHg or more and 500 mmHg or less. Further, the electrode material drying method includes transferring the electrode material dried in the intermediate heating step from the sub-current collector to a main current collector.

Furthermore, J P 2011-216227 A discloses that a binder is segregated on the surface side of the electrode material applied to the sub-current collector by heating in an intermediate heating unit. Further, J P 2011-216227 A discloses that the electrode material is thereafter transferred from the sub-current collector to the main current collector in a transfer unit, and the electrode material is bound to the main current collector on the surface on which the binder is segregated. It is disclosed that as a result, the binding strength between the electrode material and the main current collector can be improved.

JP 2024-034047 A discloses a method of manufacturing a bipolar electrode (electrode stack), including: fabricating a stack having a current collector, a positive electrode layer disposed on one surface of the current collector, and a negative electrode layer disposed on the other surface of the current collector; and roll-pressing the stack from both surfaces using opposing press rolls. In the pressing step, the press roll disposed on one side has a holding angle.

JP 2006-128039 A discloses a method of manufacturing a bipolar battery electrode using a double-coated electrode (electrode stack) for a bipolar battery. In this manufacturing method, an active material that is hard to be crushed is first applied to one surface of a current collector and pressed. Thereafter, an active material that is easily crushed is applied to the remaining surface and pressed.

### SUMMARY

There is room for improvement from the viewpoint of suppressing cracking of an electrode active material layer at the time of manufacture of an electrode stack.

An object of the present disclosure is to provide a method of manufacturing an electrode stack capable of suppressing cracking of an electrode active material layer, and a method of manufacturing a battery including such a method of manufacturing an electrode stack.

The present disclosers have found that the above issue can be addressed by the following means.

### First Aspect

A method of manufacturing an electrode stack, including the following and not including winding the stack in a roll after step (c):
(a) forming an electrode active material layer by applying an electrode mixture slurry to a transfer sheet and drying the applied electrode mixture slurry;
(b) providing a current collector; and
(c) obtaining the stack by transferring the electrode active material layer to at least one surface of the current collector.

### Second Aspect

The method according to the first aspect, in which the step (c) includes transferring a negative electrode active material layer as the electrode active material layer to one surface of the current collector, and transferring a positive electrode active material layer as the electrode active material layer to the other surface of the current collector.

### Third Aspect

The method according to the second aspect, in which a size of the negative electrode active material layer is larger than a size of the positive electrode active material layer.

### Fourth Aspect

The method according to the third aspect, further including pressing at least the negative electrode active material layer after the step (a).

### Fifth Aspect

A method of manufacturing a battery, including manufacturing an electrode stack by the method according to any one of the first to fourth aspects.

According to the method of the present disclosure, it is possible to suppress cracking of an electrode active material layer at the time of manufacture of an electrode stack. It is also possible to manufacture a battery including the thus manufactured electrode stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an exemplary disclosed process for manufacturing an electrode stack; and

FIG. 2 is a schematic diagram illustrating an example of a method of the present disclosure for manufacturing an electrode stack.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Method for Manufacturing Electrode Stack

The method of the present disclosure for producing an electrode stack comprises the following steps and does not comprise, after step (c), the step of winding the laminate in a roll:
(a) An electrode mixture material is coated on the transfer sheet, and the coated electrode mixture material is dried to form an electrode active material layer;
(b) Providing a current collector, and
(c) Transfer the electrode active material layer to at least one surface of the current collector to obtain a laminate.

The inventors of the present disclosure have found that, in the case of the following manufacturing method tail disclosed in JP 2011-216227 A, cracks may occur in the electrode active material layer. The electrode mixture slurry is coated on the transfer sheet, and the binder contained in the electrode mixture slurry is segregated near the surface by heating to form an electrode active material layer on the transfer sheet, and then the electrode active material layer is transferred from the transfer sheet to the current collector.

The inventors of the present disclosure considered that one of the causes of occurrence of cracks in the electrode active material layer is that the density of the binder in the vicinity of the surface of the electrode active material layer after transfer is low. Specifically, although this is not intended to be bound by any theory, it is presumed as follows. That is, before transfer, the binder is segregated in the vicinity of the surface of the electrode active material layer, and after transfer, the density of the binder in the vicinity of the surface of the electrode active material layer is considered to be low. In such a case, the flexibility in the vicinity of the surface of the electrode active material layer is low, and it is considered that the electrode active material layer breaks when, for example, bending stress is applied to the electrode active material layer. Here, the case where bending stress is applied to the electrode active material layer includes, for example, a case in which an electrode stack is manufactured by a roll-to-roll method, that is, after transfer of the electrode active material layer, the laminate including the electrode active material layer is wound in a roll shape.

In this regard, the inventors of the present disclosure have found that, in manufacturing an electrode stack by transferring an electrode active material layer to a current collector, cracking of the electrode active material layer can be suppressed by not including a step of winding the laminate including the electrode active material layer in a roll shape. The reason for this is not intended to be bound by any theory. However, since the step of winding the laminate including the electrode active material layer in a roll form is not included, it is possible to prevent bending stress from being applied to the electrode active material layer, and as a result, it is considered that cracking of the electrode active material layer can be suppressed.

In the context of the present disclosure, the term “electrode stack” means a stack of an electrode active material layer and a current collector, which is a component through which a current can flow. The “electrode stack” may be a negative electrode stack or a positive electrode stack. For example, when the electrode stack means a negative electrode stack, the negative electrode stack is a stack of a negative electrode active material layer and a negative electrode current collector. When the electrode stack means a positive electrode 20 stack, the positive electrode stack is a stack of a positive electrode active material layer and a positive electrode current collector.

Hereinafter, a method of manufacturing an electrode according to the present disclosure will be described with reference to the drawings. The dimensional relationship in the drawings does not reflect the actual dimensional relationship.

### Formation of the Electrode Active Material Layer

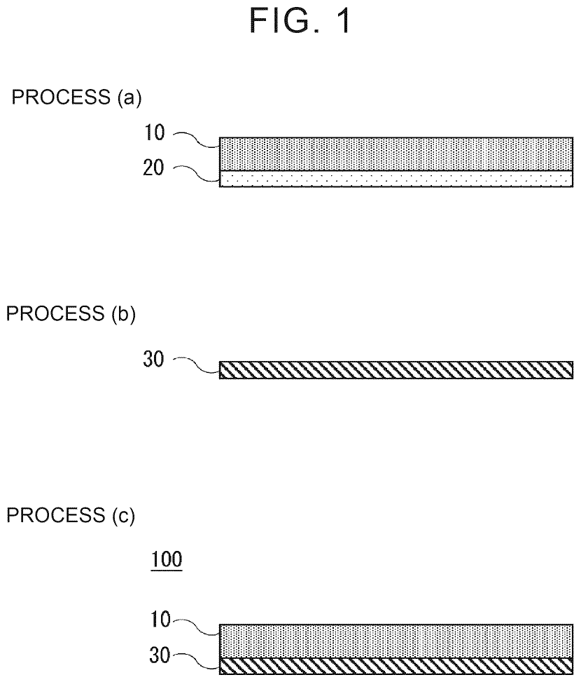

As illustrated in FIG. 1, the method of the present disclosure for manufacturing the electrode stack 100 includes a step (a) of applying an electrode mixture slurry to the transfer sheet 20 and drying the coated electrode mixture slurry to form the electrode active material layer 10.

The method of applying the electrode mixture slurry to the transfer sheet is not particularly limited, and a conventional method can be employed.

The method of drying the electrode mixture slurry is not particularly limited, and a conventional method can be employed.

The drying method of the electrode mixture slurry, and the drying conditions such as the drying time and the drying temperature can be appropriately set in accordance with the ease of segregation of the binder and the like.

### Provision of Current Collectors

As illustrated in FIG. 1, a method of the present disclosure for manufacturing an electrode stack 100 includes (b) providing a current collector 30.

The method of providing the current collector is not particularly limited, and for example, a commercially available product of a material functioning as a current collector may be used, and a material produced by a conventional method may be used. In addition, the current collector to be provided may be a current collector which is wound in a roll state in advance and cut to a predetermined size.

### Transfer of the Electrode Active Material Layer

As illustrated in FIG. 1, the method of the present disclosure for manufacturing the electrode stack 100 includes a step (c) of transferring the electrode active material layer 10 to at least one surface of the current collector 30. The method of the present disclosure does not include the step of winding the laminate into a roll after step (c). In particular, the method of the disclosure does not comprise the step of bending the laminate during and after the transfer of step (c). As described above, by adopting such a configuration, it is possible to prevent bending stress from being applied to the electrode active material layer, and as a result, it is considered that cracking of the electrode active material layer can be suppressed. Incidentally, in the present disclosure, the electro active material layer is curved state means a state in which the curvature radius of the electrodes active material layer is 100 cm, below 90 cm, below 80 cm, below 70 cm, below 60 cm, or below 50 cm.

When a roll-to-roll method is adopted, for example, in manufacturing an electrode stack, a step of winding a laminate including an electrode active material layer in a roll form may be included. In the method of the present disclosure, for example, by not employing the roll-to-roll method, it is possible to prevent the step of winding the laminate including the electrode stack into a roll shape, and in particular, the step of bending the electrode active material layer during and after the transfer of the step (c). Specifically, for example, by providing a current collector having a predetermined size to such an extent that it is not appropriate to adopt a roll-to-roll method, it is possible to prevent the electrode active material layer from being curved.

The “predetermined size” with respect to the current collector may mean, for example, the following size when a battery is manufactured using the electrode stack manufactured by the method of the present disclosure. After step (c), without cutting the electrode stack, or the reduction in the area of the electrode stack by cutting the electrode stack may be 50% or less, 40% or less, 30% or less, 20% or less, or 10% or less, it may mean a size that can be used for manufacturing a battery. In this case, the electrode active material layer may be formed in a size that can be used for manufacturing a battery in step (a), similarly to the electrode stack. With such a configuration, not only cracking of the electrode active material layer can be suppressed, but also the number of steps required after step (c) can be reduced in the case of manufacturing a battery, which has an advantage in terms of manufacturing.

A method of transferring the electrode active material layer to at least one surface of the current collector is not particularly limited, and examples thereof include a method of pressing the electrode active material layer to the current collector.

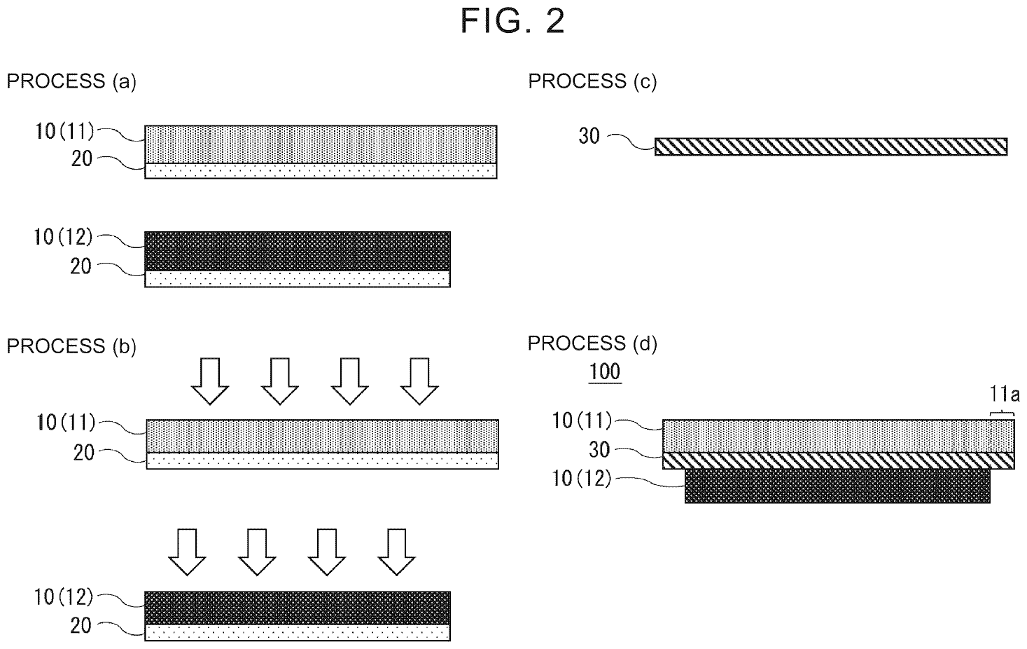

As illustrated in FIG. 2, the method of the present disclosure may include transferring the negative electrode active material layer 11 as the electrode active material layer 10 to one surface of the current collector 30 in step (c). Further, the method may include transferring the positive electrode active material layer 12 as the electrode active material layer 10 to the other surface of the current collector 30. That is, the method of the present disclosure may be a method for manufacturing a bipolar electrode stack. Note that FIG. 2 illustrates a step (a) of forming the electrode active material layer, illustrates a step (c) of providing a current collector, and illustrates a step (d) of transferring the electrode active material layer.

In the case where the method of the present disclosure is a method for manufacturing a bipolar electrode stack, the size of the negative electrode active material layer 11 may be larger than the size of the positive electrode active material layer 12 as illustrated in the steps (a), (b) and (d) of FIG. 2. In this case, as illustrated in FIG. 2, at least the negative electrode active material layer 11 may be pressed (step (b)) after step (a). When the size of the negative electrode active material layer is larger than the size of the positive electrode active material layer, the thickness of the extension portion may be larger than that of the other portions. For example, when the obtained bipolar electrode stack is pressed after the step (c), a portion of the negative electrode active material layer extending from the positive electrode active material layer (hereinafter referred to as an extension portion) 11a of the negative electrode active material layer is not appropriately pressed, and the thickness of the extension portion is sometimes thicker than other portions. As a result, cracks tend to occur in bending stress. In this regard, the Disclosing Party has found that cracking to bending stress can be suppressed by pressing at least the negative electrode active material layer after the step (a). The reason for this is not intended to be bound by any theory, but is considered to be because the negative electrode active material layer can be pressed so as to have a uniform thickness.

In the case where the method of the present disclosure is a method for manufacturing a bipolar electrode stack, the method may further include, after step (a), pressing both the negative electrode active material layer 11 and the positive electrode active material layer 12 (step (b)) as illustrated in FIG. 2. When the entire electrode stack including the positive electrode active material layer is pressed after the step (c), excessive stresses may be applied in the vicinity of the border between the extension portion 11a and other portions of the negative electrode active material layer. As a result, cracks may occur in the vicinity of the boundary in the negative electrode active material layer. In this regard, by pressing both the negative electrode active material layer and the positive electrode active material layer after the step (a), it is possible to prevent the stress from being applied, and as a result, it is possible to prevent cracking in the negative electrode active material layer near the boundary.

The method of pressing is not particularly limited, and a conventional method can be adopted.

Hereinafter, elements constituting the method of the present disclosure will be described.

### Transfer Sheet

The transfer sheet is not particularly limited as long as the formed electrode active material layer can be peeled off. The material of the transfer sheet may be, for example, a resin, a metal, or the like.

In particular, the transfer sheet may have a release property on the surface thereof. Examples of such a transfer sheet include a sheet containing a fluororesin such as polytetrafluoroethylene and silicon. Further, a sheet obtained by treating a release agent on a surface of a resin, a metal, or the like is exemplified.

### Electrode Mixture Slurry

The electrode mixture slurry contains an electrode active material, a binder, and a dispersion medium. The electrode mixture slurry may optionally contain conductive aids and other components.

In the context of the present disclosure, “mixture” means a composition that can constitute an electrode active material layer or the like as it is or by further containing other components. In addition, in the context of the present disclosure, a “mixture slurry” means a slurry that includes a dispersion medium in addition to a “mixture” and that can be applied and dried to form an electrode active material layer or the like.

### Electrode Active Material

The electrode active material is not particularly limited. In the context of the present disclosure, the “electrode active material” can be used both as a “negative electrode active material” and as a “positive electrode active material”.

The negative electrode active material is not particularly limited as long as it has a lower potential than that of the positive electrode active material. When the electrode stack of the present disclosure is an electrode stack for a lithium ion secondary battery, examples of the negative electrode active material include carbonaceous materials such as graphite (artificial graphite, natural graphite), resin carbon, carbon fiber, activated carbon, hard carbon, and soft carbon. Examples of the negative electrode active material include metal-based materials mainly composed of tin, a tin alloy, silicon, a silicon alloy, gallium, a gallium alloy, indium, an indium alloy, aluminum, an aluminum alloy, and the like. Examples of the negative electrode active material include conductive polymers such as polyacene, polyacetylene, and polypyrrole. Examples of the negative electrode active material include metallic lithium and lithium-titanium complex oxides such as Li₄Ti₅O₁₂. Examples of the negative electrode active material include lithium alloys such as Li—Si alloys, Li—Sn alloys, Li—Al alloys, Li—Ga alloys, Li—Mg alloys, and Li—In alloys. These negative active substances may be used in one type alone or a combination of two or more types.

The content of the negative active material in the negative gating material as an electrode material may be more than 50% by mass, 70% by mass, more than 90% by mass, or more than 95% by mass.

The shape of the negative electrode active material may be, for example, particulate.

The positive electrode active material is not particularly limited as long as it has a noble potential as compared with the negative electrode active material. When the electrode stack of the present disclosure is an electrode stack for a lithium ion secondary battery, examples of the positive electrode active material include complex oxides such as lithium cobaltate (LiCoO₂), lithium nickelate (LiNiO₂), lithium manganate (LiMn₂O₄), solid solution oxide (Li₂MnO₃—LiMO₂ (M═Co, Ni, etc.)), lithium nickel manganate (LiNi_{1/2}Mn_{1/2}O₂), lithium nickel cobalt manganate (LiNi_{1/3}Mn_{1/3}CO_{1/3}O₂), and olivine-type lithium phosphate (LiFePO₄). Examples of the positive electrode active material include conductive polymers such as polyaniline and polypyrrole. Examples of the positive electrode active material include sulfide-based positive electrode active materials such as Li₂S, CuS, Li—Cu—S compound, TiS₂, FeS, MoS₂, Li—Mo—S compound, Li—Ti—S compound, and Li—V-S compound. Examples of the positive electrode active material include an acetylene black impregnated with sulfur, a porous carbon impregnated with sulfur, and a material containing sulfur as an active material such as a mixed powder of sulfur and carbon. These positive electrode active materials may be used singly or in a combination of two or more.

The content of the positive pole active material in the positive pole gating material as an electrode material may be more than 50% mass, more than 70% mass, more than 90% mass, or more than 95% mass.

The shape of the positive electrode active material may be, for example, particulate.

### Binder

In the context of the present disclosure, the binder may segregate on the surface of the electrode active material layer during drying in step (a). As a result, it may have a function of facilitating separation of the transfer sheet and the electrode active material layer at the time of transfer in the step (c). Further, after the transfer in the step (c), a function of improving the binding strength between the electrode active material layer and the current collector may be provided.

The binder is not particularly limited, but when the bipolar battery of the present disclosure is a lithium ion secondary battery, examples of the binder include polyvinylidene fluoride (PVdF), polytetrafluoroethylene, polyethylene, polypropylene, aramid resin, polyamide, polyimide, polyamideimide, polyvinyl alcohol, polyacrylonitrile, polyacrylic acid, methyl polyacrylate, ethyl polyacrylate, hexyl polyacrylate, polymethacrylic acid, methyl polymethacrylate, ethyl polymethacrylate, polyhexyl methacrylate, polyvinyl acetate, polyvinyl pyrrolidone, polyether, polyether sulfone, polyhexafluoropropylene, styrene butadiene rubber, and carboxymethyl cellulose. These binders may be used singly or in a combination of two or more.

The content of the binder in the electrode mixture is not particularly limited, and can be appropriately set according to a desired binding property or the like.

### Dispersion Medium

The dispersion medium may include a non-polar solvent or a polar solvent, or a combination thereof. Examples of the non-polar solvent include heptane, xylene, toluene, and the like, or a combination thereof. Examples of the polar solvent include water, tertiary amine solvents such as triethylamine, ether solvents such as cyclopentyl methyl ether, thiol solvents such as ethane mercaptan, ester solvents such as butyl butyrate, and the like, or a combination thereof.

### Conductive Auxiliary Agent

The conductive auxiliary agent is not particularly limited, but when the bipolar battery of the present disclosure is a lithium ion secondary battery, examples of the conductive auxiliary agent include graphites such as natural graphite and artificial graphite. Examples of the conductive auxiliary agent include carbon blacks such as acetylene black, Ketjen black, channel black, furnace black, lamp black, and thermal black. Examples of the conductive auxiliary agent include carbon fibers such as carbon nanotubes and conductive fibers such as metal fibers. Examples of the conductive auxiliary agent include metal powders such as aluminum powder; and conductive whiskers such as zinc oxide whiskers and conductive potassium titanate whiskers. Examples of the conductive auxiliary agent include conductive metal oxides such as titanium oxide; organic conductive materials such as a phenylene derivative; and the like. These conduction aids may be used in one single type or a combination of two or more types.

The content of the conductive auxiliary agent in the electrode mixture is not particularly limited, and can be appropriately set in accordance with desired conductivity or the like.

### Other Ingredients

The electrode mixture may contain components other than those described above. Examples of such components include dispersants. Examples of the dispersant include carboxymethylcellulose.

### Current Collector

As the current collector, one known as a current collector of an electrode can be employed. The current collector may be, for example, a copper foil, a copper alloy foil, a nickel foil, an aluminum foil, an aluminum alloy foil, a stainless steel foil, a carbon sheet, or the like.

In particular, when the method of the present disclosure is a method for manufacturing a bipolar electrode stack, the current collector may have two different types of current collectors. In this case, the current collectors may be bonded to each other via a conductive adhesive layer, or may be bonded by pressing or the like. For example, the current collector on the negative electrode active material layer side may be a copper foil, and the current collector on the positive electrode active material layer side may be an aluminum foil.

The thickness of the current collector is not particularly limited, but may be 1 μm or more and 300 μm or less, 5 μm or more and 200 μm or less, or 10 μm or more and 100 μm or less. When the current collector has two types of current collectors bonded to each other via a conductive adhesive layer, the total thickness of each layer may be in the above range.

The size of the current collector is not particularly limited, but may be a predetermined size, in particular, a size that can be used for manufacturing a battery as it is, from the viewpoint of making it easy to manufacture the electrode stack without including the step of winding the laminate into a roll after the step (c), as described above.

The planar shape of the current collector is not particularly limited, but may be, for example, a rectangle such as a rectangle.

### Conductive Adhesive Layer

When the current collector has two types of current collectors different from each other, the current collectors may be bonded to each other by a conductive adhesive layer interposed between the current collectors.

The material of the conductive adhesive layer is not particularly limited. The electrically conductive adhesive layer may comprise an electrically conductive adhesive, i.e. for example a mixture of an adhesive and an electrically conductive component.

The adhesive may comprise a curable resin. Examples of the curable resin include a thermosetting resin and a photocurable resin. More specifically, examples of the curable resin include an olefinic resin and an acrylic resin.

The conductive adhesive layer may include a water-based adhesive as an adhesive. When the adhesive in the conductive adhesive layer is a water-based adhesive, moisture tends to remain in the conductive adhesive layer in the manufacturing process, and therefore, the advantage applied to the current collector for a bipolar battery of the present disclosure is greater. The water-based adhesive is not particularly limited, and examples of the water-based curable resin include an aqueous dispersion-based olefin-based resin.

The conductive component is not particularly limited as long as it has higher conductivity than the adhesive, and examples thereof include metal particles such as gold, silver, platinum, zinc, stainless steel, nickel, copper, cobalt, molybdenum, antimony, iron, and chromium. Examples of the conductive component include alloy particles such as an aluminum-magnesium alloy and an aluminum-nickel alloy. Examples of the conductive component include metal oxide particles such as tin oxide and indium oxide. Examples of the conductive component include particles obtained by coating metal particles such as nickel with noble metals such as gold, silver, and platinum. Examples of the conductive component include particles obtained by coating non-conductive particles such as glass, ceramic, and plastic with noble metals such as gold, silver, and platinum. Examples of the conductive component include particles obtained by plating non-conductive particles such as plastic with a metal such as nickel. Examples of the conductive component include carbon particles of graphites such as natural graphite and artificial graphite, and carbon blacks such as acetylene black, Ketjen black, channel black, furnace black, lamp black, and thermal black.

### Electrode Active Material Layer

The electrode active material layer can be produced by drying the electrode mixture slurry applied to the transfer sheet.

The thickness of the electrode active material layer is not particularly limited. The thickness of the electrode active material layer may be 100 μm or more and 1000 μm or less, 200 μm or more and 750 μm or less, or 300 μm or more and 500 μm or less before pressing. The thickness of the electrode active material layer may be 10 μm or more and 500 μm or less, 100 μm or more and 450 μm or less, or 200 μm or more and 400 μm or less after pressing.

The size of the electrode active material layer is not particularly limited. For example, as described above, the size of the electrode active material layer may be a predetermined size, in particular, a size that can be used for manufacturing a battery as it is, from the viewpoint of making it easy to manufacture the electrode stack without including the step of winding the laminate in a roll shape after the step (c).

The planar shape of the electrode active material layer is not particularly limited, but may be, for example, a rectangle such as a rectangle.

### Battery Manufacturing Method

The method of the present disclosure for manufacturing a battery includes manufacturing an electrode stack by the method of the present disclosure.

The battery produced by the method of the present disclosure may further comprise an electrolyte layer. In this case, for example, a battery can be manufactured by laminating the electrode stack and the electrolyte layer produced by the method of the present disclosure.

When the electrode stack manufactured by the method of the present disclosure is not a bipolar electrode stack, one of the negative electrode stack and the positive electrode stack may be an electrode stack manufactured by the method of the present disclosure. In addition, both the negative electrode stack and the positive electrode stack may be an electrode stack manufactured by the method of the present disclosure.

The battery produced by the method of the present disclosure may be a secondary battery, in particular a lithium-ion secondary battery.

The battery manufactured by the method of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

### Production of Electrode Stacks

### Preparation of Electrode Mixture Slurry

An artificial graphite as a negative electrode active material, a styrene-butadiene rubber (SBR) as a binder, carboxymethyl cellulose (CMC) as a dispersion medium, and a water-containing negative electrode mixture slurry as a dispersion medium were prepared by a conventional method.

A positive electrode mixture slurry containing lithium iron phosphate and lithium nickel cobalt manganate as a positive electrode active material, SBR as a binder, carboxymethylcellulose CMC as a dispersion medium, and water as a dispersion medium was prepared by a conventional method.

### Formation of the Electrode Active Material Layer

A negative electrode mixture slurry and a positive electrode mixture slurry were intermittently coated on a sheet of polytetrafluoroethylene as a transfer sheet. Thereafter, the coating film was dried to obtain a negative electrode active material layer and a positive electrode active material layer as electrode active material layers. Further, each electrode active material layer obtained was pressed. The thickness of the negative electrode active material layer before pressing was 350 μm, and the thickness of the coating film of the positive electrode active material layer was 320 μm. The thickness of the negative electrode active material layer after pressing was 300 μm, and the thickness of the positive electrode active material layer was 300 μm. For the negative electrode active material layer, the coating width was 1250 mm and the coating length was 1500 mm, and for the positive electrode active material layer, the coating width was 1200 mm and the coating length was 1500 mm. That is, the differences in the coating widths of the two electrode active material layers, i.e., the lengths of the extension portions, were 50 mm (one side: 25 mm).

### Provision of Current Collectors

Copper foils and aluminum foils were prepared as current collectors of different types. The copper foil and the aluminum foil were bonded to each other using a conductive adhesive in which nickel-plated grains were dispersed in an aqueous dispersion-based olefin-based resin (NZ-1015, manufactured by Toyobo McSe Co., Ltd.). Thereafter, the laminated metal foil was cut to a size that can be used as it is in manufacturing a battery, thereby providing a current collector.

### Transfer of the Electrode Active Material Layer

The negative electrode active material layer was transferred to the copper foil side of the current collector, and the positive electrode active material layer was transferred to the aluminum foil side. As a result, the electrode stack of the example was obtained.

### Comparative Example

Each electrode active material layer was formed in the same manner as in the example except that no pressing was performed in the step of forming the electrode active material layer. Thereafter, the electrode active material layer was transferred to the current collector provided by bonding the copper foil and the aluminum foil in the same manner as in Example, to obtain a laminate. Then, in the subsequent conveyance process, the laminate was pressed and wound into a roll shape. That is, the laminate was manufactured by a roll-to-roll method. The laminate was unwound from a roll of the resulting laminate and cut. Thus, an electrode stack of the comparative example was obtained.

### Evaluation

The migration index of the negative electrode active material layer on the current collector side in the electrode stack of Examples and Comparative Examples and the presence or absence of cracks in the electrode active material layer were confirmed. The “migration index” is an index for evaluating the distribution of the binder in the thickness direction of the electrode active material layer, and the numerical value is a value close to 1.0 when the binder is uniformly distributed.

As a result, the migration index of the negative electrode active material layer on the current collector side was 0.67 in Example and 0.7 in Comparative Example. That is, segregation of the binder was confirmed in both negative electrode active material layers.

On the other hand, cracks were not observed in any of the electrode active material layers in Examples, whereas cracks were observed in the extended portions of the negative electrode active material layers in Comparative Examples.

What is claimed is:

1. A method of manufacturing an electrode stack, the method comprising the following and the method not comprising winding the stack in a roll after step (c):
(a) forming an electrode active material layer by applying an electrode mixture slurry to a transfer sheet and drying the applied electrode mixture slurry;
(b) providing a current collector; and
(c) obtaining the stack by transferring the electrode active material layer to at least one surface of the current collector.

2. The method according to claim 1, wherein the step (c) includes transferring a negative electrode active material layer as the electrode active material layer to one surface of the current collector, and transferring a positive electrode active material layer as the electrode active material layer to the other surface of the current collector.

3. The method according to claim 2, wherein a size of the negative electrode active material layer is larger than a size of the positive electrode active material layer.

4. The method according to claim 3, further comprising pressing at least the negative electrode active material layer after the step (a).

5. A method of manufacturing a battery, the method comprising manufacturing an electrode stack by the method according to claim 1.
